(19) United States
(12) Patent Application Publication
(10) Pub. No.: US 2023/0351373 A1
(43) Pub. Date: Nov. 2, 2023

(54) Digital Safe, Digital Exchange

(71) Applicant: Zhihong Yang, Conroe, TX (US)

(72) Inventor: Zhihong Yang, Conroe, TX (US)

(21) Appl. No.: 17/677,912

(22) Filed: Feb. 22, 2022

(51) Int. Cl. G06Q 20/06; G06Q 20/36; G06Q 20/38

(52) U.S. Cl. CPC G06Q 20/3678; G06Q 20/065; G06Q 20/389

(57) ABSTRACT

The field of this invention is a system and method for digital storage, digital exchange of personal and business valuables from any device, including but not limited to computer, mobile phone, tablet, the cloud or single standalone hardware, using a global unique digital ID, with specific designed app and chip to store and exchange directly in person or remotely.

1. Digital Currency Exchange
A currency exchange app, with a global unique digital ID, primarily assigned by IPv6 address, anyone can exchange money with another person or entity in different currency. With specific designed chip, anyone can carry this digital device with desired amount exchange in person with another party with or without internet service.

2. Digital Safe:
A small device/card/disk/wristband, with a uniform data form and format, personal health record can be stored, carried and exchanged with medical professional, facility or hospitals.

3. Digital Exchange:
All verifications has to go back to the source. In digital world, it is the digital device itself.
Having a unique global digital ID, using IPv6 address as a public key, paired with DNS record, business can publish and made aware of its global unique digital address, associate this ID with own brand and product, make effective digital tracing trail, deter counterfeit.
For individual, using a device with global unique digital ID, paired with any local, state or government issued ID, make an effective identification verification process, and deter ID fraud.
